(19) United States
(12) Patent Application Publication
(10) Pub. No.: US 2026/0327518 A1
(43) Pub. Date: Oct. 22, 2026

(54) ALKALINE COMPOSITIONS AND METHOD FOR CLEANING ZINC-MAGNESIUM SURFACES

(71) Applicant: CHEMETALL GMBH, Frankfurt (DE)

(72) Inventors: Marcell SIX, Frankfurt (DE); Andre SCHAUS, Frankfurt (DE); Thorsten LUECKERATH, Frankfurt (DE)

(21) Appl. No.: 19/122,905

(22) PCT Filed: Nov. 3, 2023
(86) PCT No.: PCT/EP23/80654

§ 371 Date: Apr. 21, 2025

(30) Foreign Application Priority Data
Nov. 4, 2022 (EP) 22205516.2

(51) Int. Cl. C11D 3/10; C11D 3/06; C11D 3/20; C11D 3/36; C23C 22/62; C23C 22/78; C23G 1/19

(52) U.S. Cl. CPC C11D 3/10; C11D 3/06; C11D 3/2079; C11D 3/365; C23C 22/62; C23C 22/78; C23G 1/19

(57) ABSTRACT

Disclosed herein are a method of using an aqueous alkaline composition having a pH value below 10.0, where the composition includes besides water hydroxide anions a1), at least one complexing agent a2), at least one surfactant a3) and at least one of optionally condensed phosphate and borate anions a4), the method including using the composition for cleaning of surfaces of substrates, where said surfaces are at least partially made of at least one kind of steel being coated at least in portion with at least one kind of zinc-aluminum-magnesium alloy, a method for cleaning the surface by contacting with the aqueous alkaline composition, and a substrate having at least one cleaned surface obtained therefrom.

The present invention relates to a use of an aqueous alkaline composition for cleaning of surfaces of substrates, wherein said surfaces are at least partially made of at least one kind of steel being coated at least in portion with at least one kind of zinc-aluminum-magnesium alloy, to a method for cleaning said aforementioned surface, to a substrate having at least one cleaned surface obtainable therefrom, to a method for chemical pretreatment of said aforementioned cleaned substrate surface by making further use of an aqueous coating composition being suitable to form a conversion coating film onto said surface, and to a substrate having at least one chemically pretreated surface obtainable therefrom.

### BACKGROUND OF THE INVENTION

In the automotive OEM industry, manufactured car bodies or parts thereof are usually cleaned with alkaline cleaning compositions in order to remove impurities on their surfaces, which may be attached physically or chemically on the metallic surface of the substrate residual such as oils/lubricants/particles/oxidation products etc. before they enter subsequent steps of a following coating process (i.e., applying a conversion coating, an electrodeposition coating and further coatings), since such impurities typically lead to defects in subsequently formed chemical pretreatment layers and further coating layers.

At present, in the automotive industry typically alkaline cleaners are used that contain an alkalinity source, varying complexing agents such as phosphonic acids and (condensed) phosphates or borates. Such cleaners are typically operated in a comparably high pH range of pH 10 to 11, since such range usually provides an optimal compromise between a sufficient cleaning performance in order to achieve a desirably entire removal of residual oils, lubricants, particles, oxidation products etc. and a mild treatment of the car bodies or parts thereof, which are often composed of multi-metals, in order to achieve only low etching rates on these used metal substrates.

Conventional cleaning solutions, which are particularly operated at a pH value range of 10 to 11 or even higher are described in EP 0 536 823 A1 A, EP 0 541 034 A2 and WO 2009/050035 A1: EP 0 536 823 A1 A discloses a process for cleaning a metal surface, which involves preparing a cleaning solution containing sodium silicate and/or potassium silicate and surfactants, treating the metal surface with said solution, and regenerating said solution by subjecting it to ultrafiltration through an ultrafiltration membrane and recycling a permeate of said solution after ultrafiltration. The cleaning solution is disclosed therein to have a pH value of <12.0. In the examples of EP 0 536 823 A1 A, a number of cleaning solutions having a pH value of about 11.5 are individualized. EP 0 541 034 A2 discloses a method of degreasing a metal, which involves bringing a phosphate-free degreasing solution in contact with said metal to be processed, wherein said degreasing solution contains an alkali silicate, a water-soluble polycarboxylate and a non-ionic surfactant, wherein the degreasing solution initially satisfies specific conditions including having a pH in a range of from 10.5 to 12.5, and controlling said degreasing solution by adding further specific agents to it. The use of silicates in cleaning solutions is often disadvantageous, since this may lead to dry marks on cleaned parts and can lead to incrustations of the cleaner tanks, nozzles, etc. In addition, undesirably low coating weights of subsequently to be applied conversion coating films are often observed, when silicate containing cleaning solutions have been used for prior cleaning. WO 2009/050035 A1 relates to an aqueous alkaline cleaning composition for cleaning metallic surfaces that contains at least one non-ionic surfactant based on specific ethoxylated alkyl alcohols, which acts in a demulsifying manner.

The metal substrates traditionally used in the automotive industry are often composed of at least one of cold rolled steel (CRS), different forms of zinc-coated steels (e.g., hot-dip galvanized steel (HDG) or electro-galvanized steel (EG)), aluminum and a range of alloys of these mentioned materials. The substrate zinc magnesium (ZM) has in recent years become more popular and has come up as kind of a new metal substrate to be used in the automotive industry. ZM is a zinc-aluminum-magnesium alloy coated steel product that provides improved corrosion performance compared to other kinds of steel such as HDG as it is, e.g., disclosed in S. Schürz et al., Corrosion Science 2010, 52, 3271-3279. However, zinc magnesium is a comparably hard-to-treat substrate that often causes problems with either the cleaning process (e.g., insufficient wettability of the surface after cleaning) and/or with paint adhesion/corrosion performance after a standard coating/paint build-up has been typically applied in the automotive industry, when using standard medium alkaline cleaners at a comparably high pH range of 10 to 11 as outlined above. These problems apply particularly, when conversion coating compositions such as conversion coating compositions based on zirconium cations, fluorides and silanes are subsequently used for chemical pretreatment (after having performed the cleaning) in order to form a conversion coating layer onto the substrates' surfaces.

Thus, there is a need to provide a method for effectively cleaning substrates made of ZM or at least having a surface being composed of ZM, which does not lead to the disadvantages observed when using conventional cleaning compositions known in the prior art, in particular such cleaning compositions having comparably high pH values of above 10.0. In particular, there is a need to provide such a method, which does not negatively influence the corrosion resistance of these substrates and in particular shows an improved corrosion resistance and does not lead to non-sufficient adhesion properties after having subsequently applied further coatings on top of the cleaned surfaces, in particular conversion coating films, wherein the obtained cleaned ZM surfaces should further have an excellent wettability after cleaning as well.

### Problem

It has been therefore an objective underlying the present invention to provide a method for effectively cleaning substrates made of ZM or at least having a surface being composed of ZM, which does not lead to the disadvantages observed when using conventional cleaning compositions known in the prior art, in particular cleaning compositions having comparably high pH values of above 10.0. In particular, it has been an objective underlying the present invention to provide such a method, which does not negatively influence their corrosion resistance of these substrates and in particular shows an improved corrosion resistance and does not lead to non-sufficient adhesion properties after having subsequently applied further coatings on top of the cleaned surfaces, in particular conversion coating films, wherein the obtained cleaned ZM surfaces should further have an excellent wettability after cleaning as well.

### Solution

This objective has been solved by the subject-matter of the claims of the present application as well as by the preferred embodiments thereof disclosed in this specification, i.e., by the subject matter described herein.

A first subject-matter of the present invention is a use of an aqueous alkaline composition having a pH value below 10.0, wherein the composition comprises besides water at least constituents a1) to a4), which are different from one of another, namely
at least one alkalinity inducing source as constituent a1),
at least one complexing agent as at least one constituent a2),
at least one surfactant as at least one constituent a3) and
at least one of optionally condensed phosphate and borate anions as at least one constituent a4)
   for cleaning of surfaces of substrates, wherein said surfaces are at least partially made of at least one kind of steel being coated at least in portion with at least one kind of zinc-aluminum-magnesium alloy.

A further subject-matter of the present invention is a method for cleaning at least one surface of at least one substrate, wherein said surface is at least partially made of at least one kind of steel being coated at least in portion with at least one kind of zinc-aluminum-magnesium alloy, the method comprising at least step 1) and optionally also step 2), namely
1) contacting the at least one surface of the at least one substrate, which surface is at least partially made of at least one kind of steel being coated at least in portion with at least one kind of zinc-aluminum-magnesium alloy, at least in portion with the inventively used aqueous alkaline composition having a pH value below 10.0 as defined hereinbefore and hereinafter for cleaning the substrate, and
2) optionally rinsing the cleaned surface obtained after step 1) with water.

A further subject-matter of the present invention is a substrate having at least one cleaned surface, the substrate being obtainable by the inventive cleaning method as defined hereinbefore and hereinafter.

A further subject-matter of the present invention is a method for chemical pretreatment of at least one cleaned surface of at least one substrate, wherein said surface is at least partially made of at least one kind of steel being coated at least in portion with at least one kind of zinc-aluminum-magnesium alloy, wherein the cleaning has been carried out according to the inventive cleaning method as defined hereinbefore and hereinafter, the method for chemical pretreatment comprising at least step 3) and optionally also step 4), namely
3) contacting the at least one cleaned surface of the at least one substrate at least in portion with an aqueous, preferably acidic, coating composition being suitable to form a coating film, in particular conversion coating film, at least in portion onto said surface, wherein the aqueous coating composition is different from the inventively used aqueous alkaline composition as defined hereinbefore and hereinafter,
4) optionally curing or drying the coating film obtained after step 3) to give a cured or dried coating layer, wherein the obtained cured or dried coating layer preferably has a dry film thickness below 0.5 μm.

A further subject-matter of the present invention is a substrate comprising at least one surface, wherein said at least one surface has been pretreated according to the inventive chemical pretreatment method.

It has been in particular surprisingly found that the inventively used aqueous alkaline cleaning composition having a pH value below 10.0 leads to an improvement of the corrosion resistance of substrates made of ZM or at least having a surface being composed of ZM, in particular when used in combination with thin film technology, i.e., when having at least applied a conversion coating film on top of the cleaned substrate surface such as a conversion coating film, which has been formed from using an acidic aqueous composition comprising zirconium and/or titanium cations, fluoride anions and optionally at least one organosilane. In this regard, it has been in particular found that an only inferior corrosion resistance is observed when non-inventive aqueous alkaline cleaning compositions having a pH value exceeding 10.0 are used instead.

In addition, it has been unexpectedly found that using an aqueous alkaline cleaning composition having a pH value below 10.0 for cleaning substrates made of ZM or at least having a surface being at least partially composed of ZM is highly efficient in removing Mg from the outer surface of the zinc magnesium alloy as has been demonstrated by X-ray photoelectron spectroscopy (XPS) measurements, in particular when spray times >20 seconds such as >40 seconds or >60 seconds are used, while at the same time providing an excellent cleaning performance. In this regard, it has been in particular found that a much less efficient Mg removal from the outer surface is observed, when non-inventive aqueous alkaline cleaning compositions having a pH value exceeding 10.0 are used instead. In this context, it has been found that an efficient removal of Mg from the outer surface directly correlates with the corrosion performance on zinc magnesium substrates after a full paint build-up, in particular when using acidic aqueous conversion coating compositions comprising zirconium and/or titanium cations, fluoride anions and optionally at least one organosilane.

It has been further found that that the inventively used aqueous alkaline cleaning composition having a pH value below 10.0 leads to an excellent adhesion of the surface of the cleaned substrate to a conversion coating film applied on top of said surface, in particular to a conversion coating film, which has been formed by using an acidic aqueous composition comprising zirconium and/or titanium cations, fluoride anions and optionally at least one organosilane.

Moreover, it has been found that the obtained cleaned surfaces of the substrates used display an excellent wettability after cleaning.

### DETAILED DESCRIPTION OF THE INVENTION

The term “comprising” in the sense of the present invention, in connection for example with the inventively used aqueous alkaline cleaning composition having a pH value below 10.0 or with the aqueous composition being suitable to form a coating film at least in portion onto said surface, preferably has the meaning of “consisting of”. With regard, e.g., to both these compositions referred to hereinbefore, it is possible—in addition to all mandatory constituents present therein—for one or more of the further optional constituents identified hereinafter to be also included therein. All constituents may in each case be present in their preferred embodiments as identified below.

The proportions and amounts in wt.-% (% by weight) of any of the constituents given hereinafter, which are present in each of the compositions add up to 100 wt.-%, based in each case on the total weight of the respective composition.

### Use for Cleaning

A first subject-matter of the present invention is a use of an aqueous alkaline composition for cleaning of surfaces of substrates, wherein said surfaces are at least partially made of at least one kind of steel being coated at least in portion with at least one kind of zinc-aluminum-magnesium alloy.

### Substrate

The substrate has at least one surface, which is at least partially made of at least one kind of steel, said steel being coated at least in portion with at least one kind of zinc-aluminum-magnesium alloy (ZM). Thus, said surface is at least in portion made of steel, which in turn at least in portion bears a layer comprising or preferably being composed of least one kind of zinc-aluminum-magnesium alloy. Hence, the substrate has at least one metallic surface. Preferably, not only at least one surface of the substrate is metallic, but the substrate as such is metallic. ZM is known to a person skilled in the art as it is, e.g., described in S. Schürz et al., Corrosion Science 2010, 52, 3271-3279. ZM substrates and substrates having at least one surface, which is at least partially made of ZM, are commercially available. Preferably, the layer comprising or preferably being composed of the least one kind of zinc-aluminum-magnesium alloy contains an amount of zinc of >80.0 wt.-%, of Al of <15.0 wt.-% and of Mg of <5.0 wt.-%, in each case calculated as metal, and in each case based on the total weight of the layer. The sum of all elements present in the alloy layer sums up to 100 wt.-%. Preferably, the alloy layer weight of the least one kind of zinc-aluminum-magnesium alloy present on the steel surface is <800 g/m², preferably <500 g/m².

Preferably, the substrate used is an electrically conductive substrate, which is used customarily and known to the skilled person. The substrate can have all sorts of geometry and shape such as coils and sheets as well as parts such as automotive parts including vehicle parts such as wheel parts and other workpieces. Particularly suitable substrates are parts of vehicle bodies or complete bodies of automobiles for production.

### Aqueous Alkaline Composition

The aqueous alkaline composition has a pH value below 10.0 and comprises besides water at least one alkalinity inducing source as constituent a1), at least one complexing agent as at least one constituent a2), at least one surfactant as at least one constituent a3) and at least one of optionally condensed phosphate and borate anions as at least one constituent a4). Constituents a1) to a4) are different from one of another. The aqueous alkaline composition can be prepared from a concentrate containing at least constituents a1) to a4) by dilution of the concentrate with water.

Preferably, the aqueous alkaline composition has a pH value in a range of from >7.5 to <10.0 or ≤9.9, more preferably of from >8.0 to <10.0 or ≤9.9, even more preferably of from >8.5 to <10.0 or ≤9.9, still more preferably of from >9.0 to <10.0 or ≤9.9, yet more preferably of from >9.2 to <10.0 or ≤9.9, even more preferably of from >9.4 or ≥9.5 to <10.0 or ≤9.9 or ≤9.8. Preferably, the pH value is measured at 55° C. The pH value can be in particular adjusted by using constituent a1), in particular sodium and/or potassium hydroxide and/or carbonate, for alkaline adjustment, and can be in particular adjusted in case acidic adjustment is needed by at least one inorganic acid such as phosphoric and/or boric acid.

The term “aqueous” with respect to the aqueous composition used in step 1) in the sense of the present invention preferably means that the composition is a composition containing at least 50 wt.-%, preferably at least 60 wt.-%, more preferably at least 70 wt.-% in particular at least 80 wt.-%, most preferably at least 90 wt.-% of water, based on its total content of organic and inorganic solvents including water. Thus, the aqueous composition may contain at least one organic solvent besides water-however, in an amount lower than the amount of water present. Preferably, the aqueous composition contains at least 50 wt.-%, preferably at least 60 wt.-%, more preferably at least 70 wt.-% in particular at least 80 wt.-%, most preferably at least 90 wt.-% of water, in each case based on its total weight.

Preferably, the aqueous alkaline composition has a temperature in a range of from 40 to 70° C., preferably of from 45 to 60° C., more preferably of from 50 to 55° C.

The total amount of all components (constituents) present in the aqueous alkaline composition used in step 1) adds up to 100 wt.-%. The aqueous alkaline composition can be a dispersion or solution. Preferably, it is a solution.

Preferably, the aqueous alkaline composition is free or essentially free of silicates. “Essentially free” in this context means that at least on purpose no silicate is added, but it may not be ruled out that any silicate residues may be present as impurities.

Preferably, the amount of silicates present in the aqueous alkaline composition does not exceed 100 ppm, calculated as SiO₂. Hence, preferably the aqueous alkaline composition comprises a maximum amount of silicate of <100 ppm, calculated as SiO₂.

### Constituent a1)

At least one alkalinity inducing source (alkalinity source) is present as constituent a1). All kinds of alkalinity inducing sources, in particular anion sources, can be used. Preferably, at least one hydroxide anion and/or carbonate anion source, preferably a metal salt such as sodium and/or potassium hydroxide and/or carbonate, in particular potassium hydroxide and/or carbonate, is used for preparing the aqueous alkaline composition. Hence, the aqueous alkaline composition comprises preferably hydroxide and/or carbonate anions as constituent a1). Most preferred are carbonates as constituents a1), preferably carbonates generated from potassium carbonate.

Preferably, the aqueous alkaline composition comprises the at least one alkalinity inducing source present as constituent a1) in an amount such that the required alkalinity and the required pH vale of below 10.0 are met. More preferably, the aqueous alkaline composition comprises the at least one alkalinity inducing source present as constituent a1) in an amount of from 0.2 to 20 g/L, still more preferably of from 1.0 to g/L, even more preferably of from 3 to 8 g/L. As mentioned hereinbefore, the aqueous alkaline composition can be prepared from a concentrate by dilution of the concentrate with water. Preferably, the concentrate comprises the at least one alkalinity inducing source present as constituent a1) in the composition in an amount 10 of from 5 to 300 g/L, more preferably of from 10 to 200 g/L, even more preferably of from 20 to 100 g/L.

### Constituent a2)

At least one complexing agent is present as at least one constituent a2). Suitable complexing agents are known to a person skilled in the art.

Preferably, the at least one complexing agent present as at least one constituent a2) is selected from (i) carboxylic acids, salts thereof, derivatives, in particular esters, thereof, and mixtures thereof, wherein the carboxylic acids include polymeric carboxylic acids in each case, (ii) sulfamic acids, (iii) phosphonic acid, phosphonates and derivatives of phosphonic acid such as esters thereof, (iv) polyols, in particular having two or more OH-groups, wherein the polyols include polymeric polyols, and (v) polyethyleneimines, and mixtures of (i) to (v). More preferably, the at least one complexing agent present as at least one constituent a2) is selected from (i) carboxylic acids, salts thereof, derivatives, in particular esters, thereof, and mixtures thereof, wherein the carboxylic acids include polymeric carboxylic acids in each case, (iii) phosphonic acid, phosphonates and derivatives of phosphonic acid such as esters thereof, and mixtures thereof. Even more preferably, the at least one complexing agent present as at least one constituent a2) is selected from (i) carboxylic acids, salts thereof, derivatives, in particular esters, thereof, and mixtures thereof, wherein the carboxylic acids include polymeric carboxylic acids in each case. Exemplary suitable complexing agents are HEDP (1-hydroxyethylidene-1,1-diphosphonic acid), EDTMP (ethylenediamine tetra(methylene phosphonic acid), MGDA-Na3 (methylglycinediacetic acid trisodium salt), DTPA-Na5 (diethylenetriaminepentaacetic acid pentasodium salt), PBTC-Na4 (2-phosphonobutane-1,2,4,-tricarboxylic acid tetrasodium salt), polyethyleneimines, amido sulfonic acid, and mixtures thereof.

Preferably, the aqueous alkaline composition comprises the at least one complexing agent present as the at least one constituent a2) in an amount of from 0.2 to 10 g/L, more preferably of from 0.2 or 0.5 to 5 g/L, even more preferably of from 0.5 to 3 g/L.

### Constituent a3)

At least one surfactant is present as at least one constituent a3).

The term surfactant (surface active agent) as used herein is preferably used in accordance with the term “tenside” as defined in Rompp Lexikon “Lacke und Druckfarben” (Publisher: Ulrich Zorll, Editor: Hans-Jürgen P. Adler-Stuttgart; New York: Thieme, 1998; term: “tenside” pages 557 and 558). Surfactants act in a demulsifying manner.

Suitable surfactants are known to a person skilled in the art and, e.g., disclosed in WO 2020/200838 A1.

Preferably, the at least one surfactant is selected from non-ionic, anionic and/or cationic surfactants, most preferably from non-ionic surfactants.

Suitable non-ionic surfactants include in particular alkylphenol alkoxylates, especially alkylphenol ethoxylates, having C₆ to C₁₄ alkyl chains and a degree of alkoxylation of 5 to 30 mol per mole of phenol, alkylpolyglucosides having an alkyl chain length of C₈ to C₂₂, preferably C₁₀ to C₁₈, and containing 1 to 20, preferably 1 to 5, glucoside units, fatty acid amide alkoxylates, fatty acid alkanolamide alkoxylates, N-alkylglucamides or else block copolymers consisting of ethylene oxide, propylene oxide and/or butylene oxide, and alkoxylated C₈ to C₂₂ alcohols such as fatty alcohol alkoxylates, oxo-process alcohol alkoxylates and Guerbet alcohol alkoxylates, where the alkoxylation may take place with ethylene oxide, propylene oxide, butylene oxide and/or a mixture of these, as a block copolymer or random copolymer. The alcohols preferably have 8 to 18 carbon atoms; the degree of alkoxylation ranges typically between 2 to 50 mol, preferably 3 to 20 mol, of at least one of the stated alkylene oxides per mole of alcohol.

The alkylene oxide head group may additionally contain the following so-called end-capping groups as a modification: benzyl, methyl and/or tert-butyl capping.

Depending on application, the following anionic surfactants in particular can be used: fatty alcohol sulfates having alkyl chain lengths of 8 to 22, preferably 10 to 18, carbon atoms, for example lauryl sulfate, cetyl sulfate, myristyl sulfate, palmityl sulfate or stearyl sulfate, alkyl ether sulfates having alkyl chain lengths of 8 to 22, preferably 10 to 18, carbon atoms, and linear C₈ to C₂₀ alkylbenzenesulfonates or else alkanesulfonates and soaps, such as sodium or potassium salts of C₈ to C₂₄ carboxylic acids.

Cationic surfactants employed, depending on application, are in particular quaternary mono- and di-(C₇-C₂₅ alkyl)dimethylammonium compounds, ester quats, especially quaternary esterified mono-, di- and trialkanolamines esterified with C₈-C₂₂ carboxylic acids, and C₇ to C₂₅ alkylamines, N, N-dimethyl-N-(hydroxy-C₇-C₂₅ alkyl) ammonium salts and/or imidazoline quats.

As outlined above, however, the at least one surfactant preferably is at least one non-ionic surfactant. Within the majority of applications, the foaming tendency of anionic surfactants is too high, while cationic surfactants often attach to the metallic surface, and may consequently give rise to problems within the deposition of conversion coating films to be subsequently applied.

Preferably, the aqueous alkaline composition comprises the at least one surfactant as the at least one constituent a3) in an amount of from 0.3 to 10.0 g/L, more preferably of from 0.4 to 5.0 g/L, even more preferably of from 0.5 to 3.5 g/L.

### Constituent a4)

At least one of optionally condensed phosphate and borate anions is present as at least one constituent a4). If phosphate anions are present, these can be present in a condensed form such as in case of pyrophosphates (diphosphates) and/or in a non-condensed form. In other words, mixtures of both forms can also be present. The term “phosphates” includes polyphosphates as well such as tripolyphosphates. The term “phosphate and/or borate anions” is clear to a person skilled in the art, in particular in that this terms refers to the phosphate and/or borate anions as such, i.e., to the inorganic anions per se. These anions can be generated from suitable inorganic phosphate and/or borate anions generating precursors such as sodium and/or potassium phosphate and/or sodium and/or potassium borate. In particular, it is clear to a person skilled in the art that the term “phosphate and/or borate anions” does not include any organic phosphates and/or borates, where at least one phosphate and/or borate group is covalently bonded to an organic residue such as in, for instance, organic phosphate polyether esters.

Preferably, at least optionally condensed phosphate anions are present as constituent a4), preferably both condensed (such as diphosphate anions) and non-condensed phosphate anions are present as constituent a4), preferably wherein the aqueous alkaline composition is free or essentially free of borates.

Preferably, the aqueous alkaline composition comprises the at least one of optionally condensed phosphate and borate anions, more preferably at least optionally condensed phosphate anions, even more preferably both condensed and non-condensed phosphate anions, as the at least one constituent a4) in an amount of from 0.5 g/L to 10 g/L, more preferably of from 1.0 to 8 g/L, calculated as P₂O₅.

### Optional Constituents

The aqueous alkaline composition may comprise further optional constituents besides constituents a1) to a4), which in turn are different from any of constituents a1) to a4).

Preferably, the aqueous alkaline composition comprises at least one hydrotope as optional constituent a5), which is used an auxiliary additive for keeping the at least one surfactant a3) in solution within the composition. Examples are of suitables hydroptopes are alkali metal salts of carboxylic acids such as such as potassium octanoate. Preferably, if present, the at least one optional constituent a5) is present in the composition in an amount of from 0.2 to 6.0 g/L, more preferably of from 0.3 to 5.0 g/L, even more preferably of from 0.5 to 4.0 g/L.

Preferably, the aqueous alkaline composition is obtainable from a concentrate by dilution with water, preferably with deionized water, wherein the concentrate, i.e., prior to dilution, comprises besides water
at least one alkalinity inducing source, preferably hydroxide and/or carbonate anions, in particular carbonate anions, which is in turn obtainable from incorporation of a suitable metal salt such as sodium and/or potassium hydroxide and/or carbonate, in particular potassium carbonate, in an amount in a range of from 5 to 7 wt.-%, into the concentrate, based on the total weight of the concentrate,
at least one complexing agent, which is preferably selected from carboxylic acids, salts thereof, derivatives, in particular esters, thereof, and mixtures thereof, wherein the carboxylic acids include polymeric carboxylic acids in each case, in an amount in a range of from 1 to 5 wt.-%, based on the total weight of the concentrate,
at least one surfactant, preferably at least one non-ionic surfactant, in an amount in a range of from 1 to 6 wt.-%, based on the total weight of the concentrate, at least one source of optionally condensed phosphate and/or borate anions, preferably of optionally condensed phosphate anions including polyphosphate anions, more preferably of both optionally condensed (such as pyrophosphate anions) and non-condensed phosphate anions including polyphosphate anions, wherein said at least one source preferably is a metal phosphate including metal polyphosphate and/or metal pyrophosphate, such as trisodium and/or tripotassium phosphate, in particular tripotassium phosphate, and/or such as tetrasodium and/or tetrapotassium pyrophosphate, in particular tetrapotassium pyrophosphate, and/or sodium or potassium tripolyphosphate, more preferably wherein said at least one source is a metal polyphosphate and/or metal pyrophosphate such as tetrasodium sodium and/or tetrapotassium pyrophosphate, in particular tetrapotassium pyrophosphate, and/or sodium or potassium tripolyphosphate, in particular potassium tripolyphosphate, in an amount in a range of from 5 to 25 wt.-%, preferably of from 10 to 22 wt.-%, even more preferably of from 14 to 20 wt.-%, based in each case on the total weight of the concentrate, wherein in case sources for both at least one non-condensed and at least one condensed phosphate are used, the at least one source of condensed phosphate anions is preferably in an amount in a range of from 2.5 to 12.5 wt.-%, preferably of from 5 to 11 wt.-%, even more preferably of from 7 to 10 wt.-%, based on the total weight of the concentrate, and the at least one source of non-condensed phosphate anions is preferably in an amount in a range of from 2.5 to 12.5 wt.-%, preferably of from 5 to 11 wt.-%, even more preferably of from 7 to 10 wt.-%, based on the total weight of the concentrate, and
optionally at least one hydrotope as an auxiliary additive for keeping the at least one surfactant, preferably at least one non-ionic surfactant, in solution, in an amount in a range of from 7 to 10 wt.-%, based on the total weight of the concentrate.

Preferably, the aqueous alkaline composition is obtainable from a concentrate by dilution with water, preferably with deionized water, such that the concentrate is present in the composition after dilution in an amount of from 5 to 60 g/L, more preferably 15 to 40 g/L, even more preferably of from 20 to 30 g/L, based on the total weight of the composition (obtained after dilution of the concentrate).

### Method of Cleaning

A further subject-matter of the present invention is a method for cleaning at least one surface of at least one substrate, wherein said surface is at least partially made of at least one kind of steel being coated at least with at least one kind of zinc-aluminum-magnesium alloy, the method comprising at least step 1) and optionally also step 2). The inventive method may comprise one or more further additional optional steps.

All preferred embodiments described above herein in connection with the inventive use and preferred embodiments thereof are also preferred embodiments of the inventive cleaning method.

The cleaning method including cleaning step 1) preferably represents part of a pretreatment. The term “pretreatment” as used herein is preferably used in accordance with the term “surface pretreatment” as defined in Römpp Lexikon “Lacke und Druckfarben” (Publisher: Ulrich Zorll, Editor: Hans-Jürgen P. Adler—Stuttgart; New York: Thieme, 1998; term: “Oberflächenvorbehandlung” page 417). On metallic substrates or substrates having metallic surfaces including the relevant ZM substrates used in accordance with the present invention, according to DIN 50902:1994-07, the first step(s) of a surface treatment is/are often one or more cleaning step(s) with aqueous or non-aqueous cleaning compositions (also called “surface preparation step”). In case of the present invention, said step involves use of an aqueous alkaline cleaning composition.

In accordance with the above internationally valid definitions of a “pretreatment” of metallic substrates, a pretreatment method according to the present invention, hence, preferably encompasses the cleaning step 1) of the inventive method, which represents a surface preparing cleaning step, and which is different from, e.g., the chemical pretreatment step 3) and of the inventive chemical pretreatment method described hereinafter.

### Step 1)

In step 1), the at least one surface of the at least one substrate, which surface is at least partially made of at least one kind of steel being coated at least in portion with at least one kind of zinc-aluminum-magnesium alloy, is contacted at least in portion with the inventively used aqueous alkaline composition having a pH value below 10.0 for cleaning the substrate.

The term “at least in portion” preferably means in this context, in accordance with the general understanding of said term, that in some cases it might be desired or sufficient to contact not the whole surface of the substrate with the cleaning composition. If only part of the surface is contacted with the composition, it is typically the same part for all steps of the method. However, generally, it is desired to contact the whole surface of the substrate.

The “contacting” according to step 1) can be a spraying, a dipping or a roll coating step or any combination thereof. The aqueous alkaline composition can also be applied by flooding the surface or even manually by wiping or brushing. Preferred is spraying, dipping or roll coating or any combination thereof, most preferred is spraying.

The treatment time, i.e., the period of time the surface is contacted with the aqueous alkaline composition in step 1), is preferably from 15 seconds to 20 minutes, more preferably from 30 seconds to 10 minutes, and most preferably 40 seconds to 5 minutes, as for example 1 to 3 minutes.

Preferably, contacting step 1) is performed by spraying, more preferably for a period of >10 or >20 seconds, more preferably for a period of >30 or >40 seconds, the inventively used aqueous alkaline composition at least in portion onto the at least one surface of the at least one substrate.

### Optional Step 2)

According to optional step 2) the cleaned surface obtained after step 1) is rinsed with water. Tap water or deionized water, preferably deionized water can be used for rinsing.

### Further Optional Steps

Following step 1) and optionally step 2) one or more of the following optional steps can be performed in this order:
Step A-1): subjecting the surface of the substrate to acidic or alkaline pickling, i.e., etching, and subsequently rinsing the surface of the substrate,
Step B-1): contacting the surface of the substrate with an aqueous composition comprising at least one mineral acid, said aqueous composition being different from the aqueous alkaline composition used in step 1) and from the aqueous composition used in step 3), and
Step C-1): rinsing the surface of the substrate obtained after the contact according to step A-1) and/or B-1).

Optional step B-1) preferably serves to remove oxides, undesired alloy components, the skin, brushing dust etc. from the surface of the substrate and to thereby further activate the surface for the subsequent conversion treatment in step 3). Preferably, the at least one mineral acid of the composition in step B-1) is sulfuric acid and/or nitric acid, more preferably sulfuric acid.

Rinsing step C-1) and the optional rinsing step 2) are preferably performed by using deionized water or tap water.

Substrate with Cleaned Surface

A further subject-matter of the present invention is a substrate having at least one cleaned surface, the substrate being obtainable by the inventive cleaning method as defined hereinbefore and hereinafter.

All preferred embodiments described above herein in connection with the inventive use and the inventive cleaning method and in each case preferred embodiments thereof are also preferred embodiments of the inventive substrate with a cleaned surface.

### Chemical Pretreatment Method

A further subject-matter of the present invention is a method for chemical pretreatment of at least one cleaned surface of at least one substrate, wherein said surface is at least partially made of at least one kind of steel being coated at least in portion with at least one kind of zinc-aluminum-magnesium alloy, wherein the cleaning has been carried out according to the inventive cleaning method as defined hereinbefore and hereinafter, the method for chemical pretreatment comprising at least step 3) and optionally also step 4). The inventive method may comprise one or more further additional optional steps.

All preferred embodiments described above herein in connection with the inventive use, the inventive cleaning method and the inventive substrate with a cleaned surface and in each case preferred embodiments thereof are also preferred embodiments of the inventive chemical pretreatment method.

The term “chemical pretreatment” is used in accordance with EN ISO 4618:2006 (E/F/D) (term: 2.41 “chemical pre-treatment”), which represents any chemical process applied to a surface prior to the application of a coating material. According to this standard, e.g., treatments like chromatizing and phosphatizing and oxalating, which can be subsumed under the term “conversion treatment”, belong to the chemical pretreatment and thus are to be distinguished from (subsequent) coating steps, wherein coating materials, i.e., coating compositions such as powder coating compositions, electrodeposition coating compositions, aqueous or non-aqueous liquid coating materials are applied. Besides conversion treatments such as chromatizing and phosphating and oxalating, the chemical surface pretreatment may be achieved with passivation compositions and thin-film forming compositions in general, including aqueous compositions such as the composition, which is mandatorily used as chemical pretreatment composition in step 3).

### Step 3)

In step 3), the at least one cleaned surface of the at least one substrate is contacted at least in portion with an aqueous, preferably acidic, coating composition being suitable to form a coating film at least in portion onto said surface, wherein the aqueous coating composition is different from the inventively used aqueous alkaline composition. The aqueous composition used in step 3) represents a chemical pretreatment composition.

The term “at least in portion” preferably means in this context, in accordance with the general understanding of said term, that in some cases it might be desired or sufficient to contact not the whole surface of the substrate with the chemical pretreatment composition. If only part of the surface is contacted with the composition, it is typically the same part for all steps of the method. However, generally, it is desired to contact the whole surface of the substrate.

The “contacting” according to step 3) can be a spraying, a dipping or a roll coating step or any combination thereof. The aqueous composition can also be applied by flooding the surface or even manually by wiping or brushing. Preferred is spraying, dipping or roll coating, or any combination thereof.

The treatment time, i.e., the period of time the surface is contacted with the aqueous composition in step 3), is preferably from 15 seconds to 20 minutes, more preferably from 30 seconds to 10 minutes, and most preferably 45 seconds to 5 minutes, as for example 1 to 3 minutes. The temperature of the aqueous composition used in step 3) is preferably of from 5 to 50° C., more preferably of from 15 to 45° C. and most preferably from 25 to 40° C.

Preferably, the coating film formed in step 3) is a conversion coating film. Accordingly, preferably, the aqueous coating composition is a conversion coating composition (or conversion treatment composition). Hence, by performing step 3) preferably a conversion film is formed on the surface of the substrate, which has been in contact with the aqueous composition. The term “conversion treatment composition” defines, in accordance with the general understanding of said term, a composition, which, if applied to a substrate metal produces a superficial layer containing a compound of the substrate metal (often referred to as conversion coating) and an anion of an environment (ISO 2080:2008 (E/F), term: 2.3 “conversion treatment”).

The term “aqueous” with respect to the aqueous composition used in step 3) in the sense of the present invention preferably means that the composition is a composition containing at least 50 wt.-%, preferably at least 60 wt.-%, more preferably at least 70 wt.-% in particular at least 80 wt.-%, most preferably at least 90 wt.-% of water, based on its total content of organic and inorganic solvents including water. Thus, the aqueous composition may contain at least one organic solvent besides water-however, in an amount lower than the amount of water present. Preferably, the aqueous composition contains at least 50 wt.-%, preferably at least 60 wt.-%, more preferably at least 70 wt.-% in particular at least 80 wt.-%, most preferably at least 90 wt.-% of water, in each case based on its total weight.

Preferably, the aqueous composition used in step 3) is acidic. The acidic aqueous composition preferably has a pH value in a range of from 0.5 to 6.5. Preferably, the pH value is measured at room temperature (23° C.). The pH value of the acidic aqueous composition is more preferably in the range of from 1.0 to 6.0, still more preferably of from 2.0 or 3.0 to 5.5. The pH can be preferably adjusted by using nitric acid, aqueous ammonia and/or sodium carbonate if necessary.

The total amount of all components (constituents) present in the aqueous composition used in step 3) adds up to 100 wt.-%. The aqueous composition can be a dispersion or solution. Preferably, it is a solution.

Preferably, the aqueous composition used in step 3) of the chemical pretreatment method does not contain chromium ions such as Cr(VI) ions and/or Cr(III) ions.

The aqueous composition used in step 3) may comprise at least one of oxalate and phosphate anions, in particular when it is acidic.

Preferably, the aqueous composition comprises fluoride anions in an amount in a range of from 10 to 2000 mg/L, more preferably of from 15 to 1500 mg/L, even more preferably of from 20 to 1000 mg/L, still more preferably of from 25 to 500 mg/L, yet more preferably of from 25 to 500 mg/L, in each case calculated as fluorine. As it will be outlined hereinafter, preferably complex fluorides such as complexes of zirconium, titanium and/or hafnium formed with fluoride ions are present in the composition, e.g., by coordination of fluoride anions to zirconium, titanium and/or hafnium cations in the presence of water. Alternatively, fluoride anions may be generated by adding other water-soluble fluorine compounds, e.g., fluorides (other than complex fluorides of Ti, Zr and/or Hf) as well as hydrofluoric acid to the composition. The free fluoride content is determined by means of a fluoride ion sensitive electrode according to the method disclosed in the ‘methods’ section.

Preferably, the aqueous composition comprises at least one metal cation selected from the group consisting of titanium, zirconium and hafnium ions, and mixtures thereof, more preferably selected from the group of titanium and zirconium ions and mixtures thereof, even more preferably selected from zirconium ions. Preferably, the aqueous composition comprises at least one metal cation selected from the group consisting of titanium, zirconium and hafnium ions, and mixtures thereof, in an amount in a range of from 5 to 2000 mg/L, more preferably of from 7.5 to 1500 mg/L, even more preferably of from 10 to 1000 mg/L, still more preferably of from 15 to 500 mg/L, yet more preferably of from 20 to 300 mg/L, in each case calculated as metal. Preferably, a precursor metal compound is used to generate the at least one metal cation. Preferably, the precursor metal compound is water-soluble. Solubility is determined at a temperature of 20° C. and atmospheric pressure (1.013 bar). Particularly preferred zirconium, titanium and/or hafnium compounds are the complex fluorides of these metals. The term “complex fluoride” includes the single and multiple protonated forms as well as the deprotonated forms. It is also possible to use mixtures of such complex fluorides. Complex fluorides in the sense of the present invention are complexes of zirconium, titanium and/or hafnium formed with fluoride ions in the composition, e.g., by coordination of fluoride anions to zirconium, titanium and/or hafnium cations in the presence of water. The content of the at least one metal cation can be monitored and determined by the means of ICP-OES (optical emission spectroscopy with inductively coupled plasma). Said method is described hereinafter in the ‘method’ section.

Preferably, the aqueous composition comprises at least one organosilane, preferably in an amount of from 5 to 1000 mg/L, more preferably of from 5 to 500 mg/L. Examples are, e.g., (3-aminopropyl)trimethoxysilane, (3-aminopropyl)triethoxysilane, N-2-aminoethyl-3-aminopropyltrimethoxysilane, (3-mercaptopropyl)trimethoxysilane, (3-mercaptopropyl)triethoxysilane, (3-glycidyloxypropyl)trimethoxysilane and/or (3-glycidyloxypropyl)triethoxysilane, and/or vinyltrimethoxysilane. Preferably, the at least one organosilane is present therein in a hydrolized form.

Preferably, the aqueous, preferably acidic, coating composition used in step 3) comprises at least one metal ion selected from the group of titanium, zirconium and hafnium ions, and mixtures thereof, fluoride anions, and optionally at least one organosilane.

Optionally, the aqueous composition may comprise further constituents such as other metal cations (other than Zr, Ti and/or Hf) such as Cu cations, and/or at least one water-soluble polymer such as a water-soluble polymer having least one kind of functional groups selected from acid groups, hydroxyl groups, and mixtures thereof. Solubility is determined at a temperature of 20° C. and atmospheric pressure (1.013 bar). Preferably, the at least one water-soluble polymer is a homopolymer or copolymer obtainable from polymerization of at least one kind of ethylenically unsaturated monomers, wherein at least part of said monomers bear at least one kind of functional groups selected from acid groups, hydroxyl groups, and mixtures thereof, more preferably is a homopolymer or copolymer obtainable from polymerization of at least one kind of vinyl monomers and/or (meth)acrylic monomers, wherein at least part of said monomers bear at least one kind of functional groups selected from acid groups, hydroxyl groups, and mixtures thereof.

Preferably, a conversion layer formed after drying or curing, preferably drying, the film obtainable after step 3), has a coating weight determined by XRF (X-ray fluorescence spectroscopy) of: 0.5 to 500 mg/m², more preferably 1 to 400 mg/m², even more preferably 3 to 350 mg/m², still more preferably 5 to 300 mg/m², of zirconium, titanium and/or hafnium ions, preferably of zirconium and/or titanium, in particular of zirconium, each calculated as metal.

### Optional Step 3a)

Optionally, a rinsing step can be performed after step 3), according to which the film obtainable after step 3) is rinsed with water, preferably with deionized water.

### Optional Step 4)

According to optional step 4) the coating film obtained after step 3) is optionally cured or dried, preferably dried, to give a cured or dried coating layer, wherein the obtained cured or dried coating layer preferably has a dry film thickness below 0.5 μm.

The drying or curing step 4) may be preferably performed, e.g., at a temperature in the range of 15° C. to 100° C., more preferably at a temperature in the range of 18° C. to 95° C., in particular at a temperature in the range of 20° C. to 90° C. “Drying” in the sense of the present invention means physical drying by evaporation of in particular water originally present in the composition(s) used, whereas “curing” further includes a chemical reaction between at least two constituents originally present in the composition(s) and/or between at least one constituent originally present in the composition(s) and a suitable functional group present on the metallic surface or in the conversion film, e.g., in case a water-soluble polymer was present in the aqueous composition.

Preferably, the obtained cured or dried coating layer obtained after step 4) has a dry film thickness in a range of from 1 nm to <500 nm, more preferably of from 10 nm to 250 nm, in particular of from 80 to 150 nm.

Substrate with Chemically Pretreated Surface

A further subject-matter of the present invention is a substrate comprising at least one surface, wherein said at least one surface has been pretreated according to the inventive chemical pretreatment method.

All preferred embodiments described above herein in connection with the inventive use, the inventive cleaning method, the inventive substrate with a cleaned surface and the inventive chemical pretreatment method and in each case preferred embodiments thereof are also preferred embodiments of the inventive substrate with a chemically pretreated surface.

It is possible to apply one or more further coating films onto the at least one surface of the substrate obtained after step 3) or preferably after step 4) of the inventive chemical pretreatment method, e.g., in at least one further step 5), namely
5) applying a coating material composition comprising at least one film-forming polymer onto the film obtained after step 3) or onto the dried or cured, preferably dried, film, which in turn is obtainable from drying or curing the film obtainable after step 4).

The coating material composition can be, e.g., an electrodeposition coating composition, a primer coating composition, a basecoat composition or a topcoat including a clearcoat composition. It is, of course, possible to apply more than one composition subsequently to form a multilayer coating system, which is conventionally used, e.g., in the automotive industry.

### Methods

### 1. VDA621-415 Corrosion Test

VDA 621-415 (predecessor of VDA 233-102) is a cyclic corrosion test with a weekly cycle for determination of the corrosion resistance of the investigated sample. The weekly cycle consists of 1) a salt spray phase (24 h 5% NaCl salt spray at 35° C.), 2) a first condensed water climate phase (96 h warm and humid period at 40° C. with 85% RH (relative humidity)) and 3) a second condensed water climate phase (48 h at ambient conditions, i.e., at 25° C. with 50% RH). The whole duration of the test is 10 weeks. The undermining (undercreep) (both the overall average and the maximum undermining) has then been determined after having performed the test.

### 2. Volvo Mild Winter (VMW) Corrosion Test

The Volvo mild winter test is conducted in an ACT-chamber (ACT=accelerated corrosion test) without rain and is comprised of a 24 h cycle, which in turn is comprised of a period at 10° C. and 95% relative humidity (RH) for 6 h and a period at 15° C. and 65% RH for 6 h, with 2×6 h ramps for change of conditions during the cycle. The whole duration of the test is 6 weeks (42 cycles). The undermining (undercreep) (both the overall average and the maximum undermining) has then been determined after having performed the test.

### 3. Determination of Wettability (Wetting)

The test is carried out in a beaker or in a 5 L spray cabin for standard panel sizes of 190×10⁵ mm. The test panel is either immersed in or sprayed with the cleaning solution to be tested for 1 min and subsequently rinsed in a vertical rinsing bath (the entire panel must be dipped in and pulled out of the rinsing bath for at least 5 times). The degree of wettability is evaluated 10 seconds after the panel is removed from the rinsing bath and held in a vertical position. The minimum cleaning time (MCT) is achieved if at least 95% of the surface is wetted by water (small non-wetted areas are only allowed at the panel edges). If this condition is not met the cleaning and rinsing procedure must be repeated in 1 min intervals until the wettability conditions are met as described above. Afterwards, a new oiled test panel must be immersed for as long as the combined duration of the previously required 1 min runs. This is necessary, as the rinsing steps between the cleaning steps improve the degreasing performance. The MCT is achieved when the wettable surface is >95% without rinsing steps in between.

### 4. XPS Measurements

The XPS analyses were carried out with a Phi Versa Probe 5000 spectrometer using monochromatic Al Kα radiation. The XPS system was calibrated according to ISO 15472:2001. The BE (Binding Energy) of Au 4f7/2 is 84.00 eV and that of Cu2p3/2 is 932.62 eV. All samples were mounted insulated against ground and neutralized during the measurements with the built-in charge neutralizer and measured on three non-overlapping sample positions using a spot size of 200 μm×200 μm. Survey scan analyses were carried out with a pass energy of 117.4 eV and an energy step size of 0.5 eV and an acquisition range of −5 eV to 1350 eV with a dwell time of 600 ms per point. High resolution analyses of the C 1s-Signal were carried out on the same analysis area with a pass energy of 23.5 eV and an energy step size of 0.1 eV and a dwell time of 1200 ms per point in the range of 278.0-300.0 eV. The C 1s-Detail Spectra had a region defined with the following properties:
U 2 Tougaard (Crosssection-650, 0, 0)
Fit AV Width=20
End (eV Binding energy): 292.9
Start (eV Binding energy): 281.9.

The spectra were then fitted to obtain the exact position of the Hydrocarbon peak based on the following model and then charge corrected so that the maximum of Hydrocarbon peak was 284.8 eV for all samples.

| | Position | FWHM | Line |
|---|---|---|---|
| Name | (+−0.1 eV) | Constr. | Shape |
| Hydrocarbon (A) | 284.8 | 1.187, 1.287 | LA |
| B | A + 0.8 | A * 1 | (1, 1, 900) |
| C | A + 1.8 | | |
| D | A + 3.2 | | |
| E | A + 3.9 | | |
| F | A + 4.6 | | |
| G | A + 5.1 | | |
| H | A + 6.1 | | |

The survey spectra were then analyzed with the standard XPS-analysis software CasaXPS (Fairley N, (2021) CASA-XPS, 2.3.50Rev1-0D, Casa Software Ltd) for all regions of the elements of interest according to the region properties given in the following table:

| | Start (eV | End (eV | | Fit |
|---|---|---|---|---|
| | Binding | Binding | Background | AV |
| Name | energy) | energy) | Type | Width |
| Ca 2p | 356.7 | 345.0 | U 2 Tougaard | 5 |
| Zn 3p | 98.8 | 81.3 | (Crosssection −650, | |
| Al 2p | 78.3 | 69.3 | 0, 0) | |
| Mg 2p | 53.7 | 45.6 | | |

Relative sensitivity factors and transmission function as provided by the instrument manufacturer were used for quantification and the elemental ratios of Zn, Mg, Al, and Ca were then calculated based on the quantification results in atom-% for the following regions (with a varation in the onset of the spectra in the range of +−0.1 eV).

### 5. Free Fluoride Content Determination

The free fluoride content is determined by means of a fluoride ion selective electrode. The electrode is calibrated using at least three master solutions with known fluoride concentrations. The calibration process results in the building of calibration curve. Then the fluoride content is determined by using of the curve.

### 6. ICP-OES

The amounts of certain elements in a sample under analysis, such as of zirconium, titanium, hafnium etc., is determined using inductively coupled plasma atomic emission spectrometry (ICP-OES) according to DIN EN ISO 11885 (date: Sep. 1, 2009). A sample is subjected to thermal excitation in an argon plasma generated by a high-frequency field, and the light emitted due to electron transitions becomes visible as a spectral line of the corresponding wavelength and is analyzed using an optical system. There is a linear relation between the intensity of the light emitted and the concentration of the element in question. Prior to implementation, using known element standards (reference standards), the calibration measurements are carried out as a function of the particular sample under analysis. These calibrations can be used to determine concentrations of unknown solutions such as the concentration of the amount of titanium, zirconium and hafnium.

### EXAMPLES

The following examples further illustrate the invention but are not to be construed as limiting its scope.

### 1. Cleaning Compositions

### 1.1 Cleaning Composition CCC1 (Comparative)

A comparative cleaning composition CCC1 has been prepared from a concentrated starting solution. The constituents of said starting solution are displayed in Table 1a.

TABLE 1a

| Constituent | Concentration [wt.-%] |
|---|---|
| Potassium hydroxide | 10-30 |
| Sodium and potassium phosphates | 10-22 |
| Complexing agent | 0.5-5 |
| Potassium octanoate | 2-10 |
| Non-ionic surfactant | 1-6 |

As starting solution, the commercially available product Gardoclean® S 5411 has been used, to which non-ionic surfactant and potassium octanoate have been added. The resulting starting solution has subsequently been diluted with deionized water. The resulting diluted solution has then been used as process bath. The bath contained the aforementioned resulting starting solution in an amount of 20 g/L and had a temperature of 55° C.

The process bath had a pH value of 10.5. The bath is hereinafter referred to as CCC1.

### 1.2 Cleaning Composition ICC1 (Inventive)

An inventive cleaning composition ICC1 has been prepared from a concentrated starting solution. The constituents of said starting solution are displayed in Table 1b.

TABLE 1b

| Constituent | Concentration [wt.-%] |
|---|---|
| Potassium carbonate | 8-12 |
| Sodium and potassium phosphates | 14-20 |
| Complexing agent | 1-5 |
| Potassium octanoate | 2-10 |
| Non-ionic surfactant | 1-6 |

As starting solution, the commercially available product Gardoclean® S 5201/4 has been used. The starting solution has subsequently been diluted with deionized water. The resulting diluted solution has then been used as process bath. The bath contained the starting solution in an amount of 20 g/L and had a temperature of 55° C. 2-phosphonobutane-1,2,4-tricarboxylic acid was used as complexing agent.

The process bath had a pH value of 9.5. The bath is hereinafter referred to as ICC1.

### 2. Cleaning and Coating Method

Two different kinds of commercially available zinc-magnesium substrates (i.e., ZM70 and ZM100) were investigated. The substrates were treated, i.e., cleaned, by making use of composition CCC1 (comparative, pH value 10.5) or ICC1 (inventive, pH value 9.5). Both compositions were applied using spray application (pressure: 1 bar) and for different timeframes each, i.e., 20 s for CCC1 and 70 s for ICC1.

After having been cleaned, the cleaned substrates were subjected to a further contacting step in order to apply a conversion coating layer onto their cleaned surfaces. Two rinsing steps have been performed subsequently, the first one with tap water, the second one with deionized water. For this, the surfaces of the substrates were contacted with a commercially available acidic aqueous composition (Oxsilan® 9835), which inter alia comprises zirconium cations, fluoride anions and an organosilane. The contacting step was performed in each case for 180 seconds by dipping the surfaces of the substrates into the acidic aqueous composition. The acidic aqueous composition was heated to 35° C. before immersion. Two rinsing steps were then performed subsequently, the first one with tap water, the second one with deionized water. Following the rinsing steps, a drying step was performed by air blowing. Finally, a commercially available electrodeposition coating material (Cathoguard® 800) was applied on the conversion coated surface of the substrates and baked at 175° C. for 25 minutes.

### 3. Investigation of the Properties of the Cleaned and Coated Substrates

The coated substrates obtained after the method described hereinbefore in item 2. has been performed have then been investigated according to the methods described in the ‘methods’ section.

The wettability as well as the undermining values of the coated substrates determined after having performed the VMW corrosion test are summarized in Table 3a. The wettability as well as the undermining values of the coated substrates determined after having performed the VDA 621-415 corrosion test are summarized in Table 3b.

TABLE 3a

| | Cleaning | Overall average | Maximum | |
|---|---|---|---|---|
| | composition | undermining | undermining | |
| Substrate | used | [mm] | [mm] | Wetting |
| ZM70 | CCC1, 20 s | 7.4 | 11.9 | Good |
| | ICC1, 70 s | 4.5 | 6.2 | Good |
| ZM100 | CCC1, 20 s | 7 | 8.3 | Good |
| | CCC1, 70 s | 6.7 | 9.5 | Good |
| | ICC1, 70 s | 3.9 | 6.2 | Good |

TABLE 3b

| | Cleaning | Overall average | |
|---|---|---|---|
| | composition | undermining | |
| Substrate | used | [mm] | Wetting |
| ZM70 | CCC1, 20 s | 1.4 | Good |
| | ICC1, 70 s | 0.7 | Good |
| ZM100 | CCC1, 20 s | 0.9 | Good |
| | CCC1, 70 s | 1.5 | Good |
| | ICC1, 70 s | 0.6 | Good |

The presented data unambiguously demonstrates the positive effect of the inventively used alkaline cleaner on the corrosion performance on ZM substrates, in particular when used with spray times that allow for sufficient cleaning performance, and, further, particularly when used in combination with suitable conversion coating products such as Oxsilan® products.

The surface of zinc-magnesium substrates is relatively uneven with an inhomogeneous element distribution, containing areas of mostly Mg/Al/Zn and other areas of mostly Zn. It has been observed that using ICC1 at a pH below 10.0 such as at 9.5 is highly efficient in removing Mg from the outer surface of the zinc-magnesium alloy as has been demonstrated by X-ray photoelectron spectroscopy (XPS) measurements according to the method described in the ‘methods’ section. In particular, conditions using ICC1 with a pH below 10.0 such as 9.5 and longer spray times of 70 s showed to be highly efficient in removing Mg from the outer surface of both ZM70 and ZM100, while at the same time providing good cleaning performance. In contrast, CCC1 was much less efficient in Mg removal from the outer surface. The efficient removal of Mg directly correlates with the corrosion performance on zinc-magnesium after a full paint build-up, when using conversion coating chemistry compositions such as Oxsilan® compositions, which are based on zirconium, fluorides and silanes.

The values in at % of Al, Mg and Ca obtained from the XPS measurements are depicted in Table 3c below relative to the obtained zinc value in at %.

TABLE 3c
XPS results, ratios given in at %/at %

| | | Cleaning | | | |
|---|---|---|---|---|---|
| | | composition | | | |
| | | or cleaner | | | |
| | | (reference) | | | |
| | Substrate | used | Al/Zn | Mg/Zn | Ca/Zn |
| 1 (Ref) | ZM70 | Petroleum ether | 0.81 | 1.15 | 0.50 |
| 2 | ZM70 | CCC1, 20 s | 0.36 | 0.36 | 0.17 |
| 3 | ZM70 | ICC1, 70 s | 0.35 | 0.1 | 0.04 |
| 4 (Ref) | ZM100 | Petroleum ether | 0.53 | 0.76 | 0.34 |
| 5 | ZM100 | CCC1, 20 s | 0.41 | 0.51 | 0.23 |
| 6 | ZM100 | CCC1, 70 s | 0.35 | 0.32 | — |
| 7 | ZM100 | ICC1, 70 s | 0.44 | 0.10 | 0.04 |

The presented data underlines the highly efficient removal of Mg from the outer surface when applying ICC1. While a reduction in Mg is also observed with CCC1 compared to the reference samples, the XPS data clearly shows that ICC1 removes Mg much more efficiently. Interestingly, the same trend can be observed for Ca.

1. A method of using an aqueous alkaline composition having a pH value below 10.0, wherein the composition comprises besides water at least constituents a1) to a4), which are different from one of another, namely
at least one alkalinity inducing source as constituent a1),
at least one complexing agent as at least one constituent a2),
at least one surfactant as at least one constituent a3) and
at least one of optionally condensed phosphate and borate anions as at least one constituent a4),
the method comprising using the aqueous alkaline composition for cleaning of surfaces of substrates, wherein said surfaces are at least partially made of at least one kind of steel being coated at least in portion with at least one kind of zinc-aluminum-magnesium alloy.

2. The method of using the aqueous alkaline composition according to claim 1, wherein the aqueous alkaline composition has a pH value in a range of from >7.5 to <10.0 or ≤9.9.

3. The method of using the aqueous alkaline composition according to claim 1, wherein the aqueous alkaline composition is free or essentially free of silicates.

4. The method of using the aqueous alkaline composition according to claim 1, wherein at least optionally condensed phosphate anions are present as constituent a4).

5. The method of using the aqueous alkaline composition according to claim 1, wherein the aqueous alkaline composition has a temperature in a range of from 40 to 70° C.

6. The method of using the aqueous alkaline composition according to claim 1, wherein the aqueous alkaline composition comprises hydroxide and/or carbonate anions as constituent a1) and/or comprises the at least one constituent a1) in an amount of from 0.2 to 20 g/L.

7. The method of using the aqueous alkaline composition according to claim 1, wherein the at least one complexing agent present as at least one constituent a2) is selected from the group consisting of (i) carboxylic acids, salts thereof, derivatives, and mixtures thereof, wherein the carboxylic acids include polymeric carboxylic acids in each case, (ii) sulfamic acids, (iii) phosphonic acid, phosphonates and derivatives of phosphonic acid such as esters thereof, (iv) polyols, wherein the polyols include polymeric polyols, and (v) polyethyleneimines, and mixtures of (i) to (v).

8. The method of using the aqueous alkaline composition according to claim 1, wherein the at least one surfactant being present as the at least one constituent a3) is selected from the group consisting of non-ionic, anionic and cationic surfactants.

9. The method of using the aqueous alkaline composition according to claim 1, wherein the aqueous alkaline composition comprises
the at least one complexing agent as the at least one constituent a2) in an amount of from 0.2 to 10 g/L, and/or
the at least one surfactant as the at least one constituent a3) in an amount of from 0.3 to 10.0 g/L, and/or
the at least one of optionally condensed phosphate and borate anions, as the at least one constituent a4) in an amount of from 0.5 g/L to 10 g/L calculated as P₂O₅.

10. A method for cleaning at least one surface of at least one substrate, wherein said surface is at least partially made of at least one kind of steel being coated at least in portion with at least one kind of zinc-aluminum-magnesium alloy, the method comprising at least step 1) and optionally also step 2), namely
1) contacting the at least one surface of the at least one substrate, which surface is at least partially made of at least one kind of steel being coated at least in portion with at least one kind of zinc-aluminum-magnesium alloy, at least in portion with the aqueous alkaline composition having a pH value below 10.0 according to claim 1 for cleaning the substrate, and
2) optionally rinsing the cleaned surface obtained after step 1) with water.

11. The method according to claim 10, wherein contacting step 1) is performed by spraying the aqueous alkaline composition at least in portion onto the at least one surface of the at least one substrate.

12. A substrate having at least one cleaned surface, the substrate being obtained by the method according to claim 10.

13. A method for chemical pretreatment of at least one cleaned surface of at least one substrate, wherein said surface is at least partially made of at least one kind of steel being coated at least in portion with at least one kind of zinc-aluminum-magnesium alloy, wherein cleaning has been carried out according to the cleaning method of claim 10, the method for chemical pretreatment comprising at least step 3) and optionally also step 4), namely
3) contacting the at least one cleaned surface of the at least one substrate at least in portion with an aqueous coating composition being suitable to form a coating film, at least in portion onto said surface, which is different from the aqueous alkaline composition,
4) optionally curing or drying the coating film obtained after step 3) to give a cured or dried coating layer.

14. The method according to claim 13, wherein the aqueous coating composition used in step 3) comprises at least one metal ion selected from the group consisting of titanium, zirconium and hafnium ions, and mixtures thereof, fluoride anions, and optionally at least one organosilane.

15. A substrate comprising at least one surface, wherein said at least one surface has been pretreated according to the method of claim 13.

16. The method of using the aqueous alkaline composition according to claim 1, wherein the aqueous alkaline composition has a pH value in a range of from >8.0 to <10.0 or ≤9.9.

17. The method of using the aqueous alkaline composition according to claim 1, wherein the aqueous alkaline composition comprises a maximum amount of silicates of <100 ppm, calculated as SiO₂.

18. The method of using the aqueous alkaline composition according to claim 1, wherein at least optionally both condensed and non-condensed phosphate anions including polyphosphate anions are present as constituent a4).

19. The method of using the aqueous alkaline composition according to claim 1, wherein the aqueous alkaline composition is free or essentially free of borates.

20. The method of using the aqueous alkaline composition according to claim 1, wherein the aqueous alkaline composition has a temperature in a range of from 45 to 60° C.
